(19) United States
(12) Patent Application Publication
(10) Pub. No.: US 2026/0236082 A1
(43) Pub. Date: Aug. 13, 2026

(54) FIND MY DEVICE MODE FOR EXTENDED REALITY (XR) DEVICES OPERATING IN IDLE STATE

(71) Applicant: QUALCOMM Incorporated, San Diego, CA (US)

(72) Inventors: Shriharsha CHEBBI, Hyderabad (IN); Nirav Narendra DESAI, Hyderabad (IN); Aman GARG, Gachibowli (IN); Nigam Mohan PALO, Hyderabad (IN)

(21) Appl. No.: 19/053,258

(22) Filed: Feb. 13, 2025

(51) Int. Cl. G06F 1/3212; G06F 1/3209; G06F 1/3234

(52) U.S. Cl. CPC G06F 1/3212; G06F 1/3209; G06F 1/3278

(57) ABSTRACT

A method for system-on-a-chip (SoC) low power mode operation includes entering an idle state from an active state when a device search mode has not been enabled by a user. The method also includes initiating the device search mode in response to entering the idle state. The method further includes entering an inactive state after initiating the device search mode. The method still further includes exiting the inactive state into the active state, in response to receiving a power management integrated circuit (PMIC) trigger. The method includes exiting the device search mode after exiting the inactive state.

### FIELD OF THE DISCLOSURE

The present disclosure relates generally to extended reality (XR) devices, and more specifically to power optimized wearable devices, such as augmented reality (AR) glasses, operating in an idle state.

### BACKGROUND

Augmented reality (AR) merges the real world with virtual objects to support realistic, intelligent, and personalized experiences. Conventional augmented reality applications provide a live view of a real-world environment whose elements may be augmented by computer-generated sensory input such as video, sound, graphics, or global positioning system (GPS) data. With such applications, a view of reality may be modified by a computing device, to enhance a user's perception of reality and provide more information about the user's environment. Virtual reality (VR) simulates physical presence in real or imagined worlds, and enables the user to interact in that world. Achieving AR and VR functionality requires the next level of artificial intelligence (AI) and connectivity within the thermal and power envelopes of a wearable device, such as eyeglasses.

For wider market adoption, augmented reality (AR) glasses should be lightweight with a small form factor (e.g., sleek form factor). In fact, original equipment manufacturers (OEMs) may specify maximum dimension limits to achieve the sleek form factor. The sleek form factor, however, restricts chip count, chip package size, battery size, and battery capacity. Lower power consumption may improve the user experience by allowing a lower battery capacity and thus a smaller battery.

### SUMMARY

In aspects of the present disclosure, a method for system-on-a-chip (SoC) low power mode includes entering an idle state from an active state when a device search mode has not been enabled by a user. The method also includes initiating the device search mode in response to entering the idle state. The method further includes entering an inactive state after initiating the device search mode. The method still further includes exiting the inactive state into the active state, in response to receiving a power management integrated circuit (PMIC) trigger. The method also includes exiting the device search mode after exiting the inactive state.

Other aspects of the present disclosure are directed to an apparatus. The apparatus has one or more memories and one or more processors coupled to the one or more memories. The processor(s) is configured to enter an idle state from an active state when a device search mode has not been enabled by a user. The processor(s) is also configured to initiate the device search mode in response to entering the idle state. The processor(s) is further configured to enter an inactive state after initiating the device search mode. The processor(s) is still further configured to exit the inactive state into the active state, in response to receiving a power management integrated circuit (PMIC) trigger. The processor(s) is also configured to exit the device search mode after exiting the inactive state.

In other aspects of the present disclosure, a non-transitory computer-readable medium with program code recorded thereon is disclosed. The program code is executed by a processor and includes program code to enter an idle state from an active state when a device search mode has not been enabled by a user. The program code also includes program code to initiate the device search mode in response to entering the idle state. The program code further includes program code to enter an inactive state after initiating the device search mode. The program code still further includes program code to exit the inactive state into the active state, in response to receiving a power management integrated circuit (PMIC) trigger. The program code also includes program code to exit the device search mode after exiting the inactive state.

This has outlined, rather broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF DRAWINGS

The details of one or more examples of the disclosure are set forth in the accompanying drawings and the description below. Other features, objects, and advantages of the disclosure will be apparent from the description and drawings, and from the claims.

FIG. 1 illustrates an example implementation of a system-on-a-chip (SoC).

FIG. 2 is a block diagram that illustrates an example content generation and coding system to implement extended reality (XR) or virtual reality (VR) applications, in accordance with various aspects of the present disclosure.

FIG. 3 is a block diagram illustrating augmented reality or virtual reality subsystems, according to various aspects of the present disclosure.

FIG. 4 is a diagram illustrating locations of components in a wearable device with an eyeglasses form factor, in accordance with various aspects of the present disclosure.

FIG. 5 is a diagram illustrating find my device operation, in accordance with various aspects of the present disclosure.

FIG. 6 is a state transition diagram for enabling device search mode while in a device idle state, in accordance with various aspects of the present disclosure.

FIG. 7 is a flow diagram illustrating entry into a device search mode while in a device idle state, in accordance with various aspects of the present disclosure.

FIG. 8 is a flow diagram illustrating exit of a device search mode when leaving a device idle state, in accordance with various aspects of the present disclosure.

FIG. 9 is a flow diagram illustrating further details for enabling a device search mode while in a device idle state, in accordance with various aspects of the present disclosure.

FIG. 10 is a flow diagram illustrating entry and exit of a device search mode, in accordance with various aspects of the present disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings one skilled in the art should appreciate that the scope of this disclosure is intended to cover any aspect of the systems, apparatuses, computer program products, and methods disclosed, whether implemented independently of, or combined with, other aspects of the disclosure. For example, an apparatus may be implemented or a method may be practiced using any number of the aspects set forth. In addition, the scope of the disclosure is intended to cover such an apparatus or method which is practiced using other structure, functionality, or structure and functionality in addition to or other than the various aspects of the disclosure set forth. Any aspect disclosed may be embodied by one or more elements of a claim.

Although various aspects are described, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-a-chip (SoCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described, one or more techniques may refer to an application (e.g., software) being configured to perform one or more functions. In such examples, the application may be stored on a memory (e.g., on-chip memory of a processor, system memory, or any other memory). Hardware described, such as a processor may be configured to execute the application. For example, the application may be described as including code that, when executed by the hardware, causes the hardware to perform one or more techniques described. As an example, the hardware may access the code from a memory and executed the code accessed from the memory to perform one or more techniques described. In some examples, components are identified in this disclosure. In such examples, the components may be hardware, software, or a combination thereof. The components may be separate components or sub-components of a single component.

Accordingly, in one or more examples described, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for integrating subsystems or modules that are located on physically separated printed circuit boards (PCBs). For example, augmented reality or virtual reality (AR/VR) devices may have modules located physically distant from one another. However, the present disclosure is equally applicable to any type of system with modules or PCBs spaced apart but electrically connected (e.g., with a flex cable, a flex PCB, a coaxial cable, a rigid PCB, etc.) In some aspects, the solutions integrate at least one slave subsystem with a master subsystem by implementing all control and status monitor functions between the subsystems. For example, certain bi-directional functions may be implemented between master and slave subsystems, such as power ON triggers, reset triggers, shutdown triggers, fault propagation, and fail-safe reset triggers.

As used, the term “coder” may generically refer to an encoder and/or decoder. For example, reference to a “content coder” may include reference to a content encoder and/or a content decoder. Similarly, as used, the term “coding” may generically refer to encoding and/or decoding. As used, the terms “encode” and “compress” may be used interchangeably. Similarly, the terms “decode” and “decompress” may be used interchangeably.

As used, instances of the term “content” may refer to the term “video,” “graphical content,” “image,” and vice versa. This is true regardless of whether the terms are being used as an adjective, noun, or other part of speech. For example, reference to a “content coder” may include reference to a “video coder,” “graphical content coder,” or “image coder,” and reference to a “video coder,” “graphical content coder,” or “image coder” may include reference to a “content coder.” As another example, reference to a processing unit providing content to a content coder may include reference to the processing unit providing graphical content to a video encoder. In some examples, the term “graphical content” may refer to a content produced by one or more processes of a graphics processing pipeline. In some examples, the term “graphical content” may refer to a content produced by a processing unit configured to perform graphics processing. In some examples, the term “graphical content” may refer to a content produced by a graphics processing unit.

Instances of the term “content” may refer to graphical content or display content. In some examples, the term “graphical content” may refer to a content generated by a processing unit configured to perform graphics processing. For example, the term “graphical content” may refer to content generated by one or more processes of a graphics processing pipeline. In some examples, the term “graphical content” may refer to content generated by a graphics processing unit. In some examples, as used, the term “display content” may refer to content generated by a processing unit configured to perform displaying processing. In some examples, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling (e.g., upscaling or downscaling) on a frame. In some examples, a frame may refer to a layer. In other examples, a frame may refer to two or more layers that have already been blended together to form the frame (e.g., the frame includes two or more layers, and the frame that includes two or more layers may subsequently be blended)

As referenced, a first component (e.g., a processing unit) may provide content, such as graphical content, to a second component (e.g., a content coder). In some examples, the first component may provide content to the second component by storing the content in a memory accessible to the second component. In such examples, the second component may be configured to read the content stored in the memory by the first component. In other examples, the first component may provide content to the second component without any intermediary components (e.g., without memory or another component). In such examples, the first component may be described as providing content directly to the second component. For example, the first component may output the content to the second component, and the second component may be configured to store the content received from the first component in a memory, such as a buffer.

For a mobile device, such as a mobile telephone, a single printed circuit board (PCB) may support multiple components including a CPU, GPU, DSP, etc. For an augmented reality (AR) or virtual reality (VR) device, the components may be located on different PCBs due to the form factor of the AR or VR device. For example, the AR or VR device may be in the form of eyeglasses. In an example implementation, a main SoC (also referred to as a main processor) and a main power management integrated circuit (PMIC) may reside on a first PCB in one of the arms of the eyeglasses. A camera and sensor co-processor and associated PMIC may reside on a second PCB near the bridge of the eyeglasses. A connectivity processor and associated PMIC may reside on a third PCB on the other arm of the eyeglasses.

For wider market adoption, augmented reality (AR) glasses should be lightweight with a small form factor (e.g., sleek form factor). In fact, original equipment manufacturers (OEMs) may specify maximum dimension limits to achieve the sleek form factor. The sleek form factor, however, restricts chip count, chip package size, battery size, and battery capacity. Lower power consumption may improve the user experience by allowing a lower battery capacity and thus a smaller battery.

Extended reality (XR) chipsets support a find my device (FMD) feature (also referred to as a device search mode) to assist the user in case of misplacing the device. Traditionally, find my device is a chipset state where the main system-on-a-chip (SoC) is OFF, and a connectivity SoC is operational with BLUETOOTH low energy (BLE) technology enabled.

In the current chipset architecture, the find my device feature (e.g., device search mode) is enabled during a low battery event when the SoC is fully power collapsed. A user enables the search mode in a control panel, for example, while operating the device. As a result of the search mode being enabled, when the device enters the low power mode, the device enters the device search mode. If the user does not configure (e.g., enable) the device search mode, the device does not enter the device search mode when entering the low power mode. Prior action by the user is required.

Aspects of the present disclosure introduce a solution for enabling a device search mode in an enhanced quiescent (SEEQ) state for XR devices. The solution leverages the power benefit and quick exit time of deep sleep and quick boot processes, combined with the find my device feature (e.g., device search mode). The proposed solution may be implemented in AR/XR chipsets.

Aspects of the present disclosure provide a power efficient solution for XR devices in idle, unattended mode. The solution assists a user in locating the XR device in case of misplacement, even if the device is not in low battery scenario. The entry path into the low power mode leverages deep sleep and quick boot features to further enhance the battery life of the device. On the exit path, because the quick boot process is utilized, the exit latency is significantly reduced compared to returning from a power OFF state.

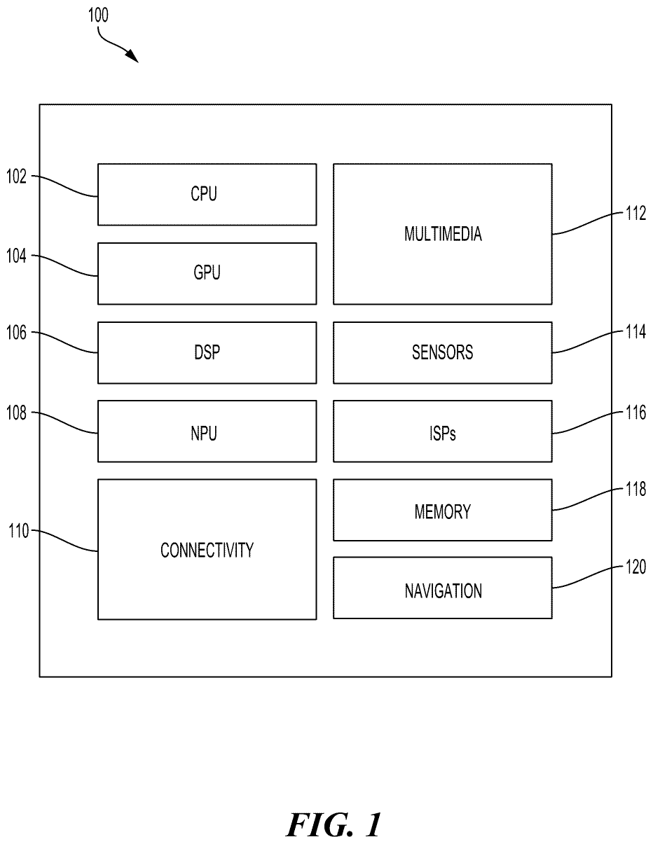

FIG. 1 illustrates an example implementation of a system-on-a-chip (SoC) 100 on a single printed circuit board (PCB). The host SoC 100 includes processing blocks tailored to specific functions, such as a connectivity block 110. The connectivity block 110 may include fifth generation (5G) new radio (NR) connectivity, fourth generation long term evolution (4G LTE) connectivity, Wi-Fi connectivity, USB connectivity, Bluetooth® connectivity, Secure Digital (SD) connectivity, and the like.

In this configuration, the SoC 100 includes various processing units that support multi-threaded operation. For the configuration shown in FIG. 1, the SoC 100 includes a multi-core central processing unit (CPU) 102, a graphics processor unit (GPU) 104, a digital signal processor (DSP) 106, and a neural processor unit (NPU) 108. The SoC 100 may also include a sensor processor 114, image signal processors (ISPs) 116, a navigation module 120, which may include a global positioning system, and a memory 118. The multi-core CPU 102, the GPU 104, the DSP 106, the NPU 108, and the multi-media engine 112 support various functions such as video, audio, graphics, extended reality (XR) gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set.

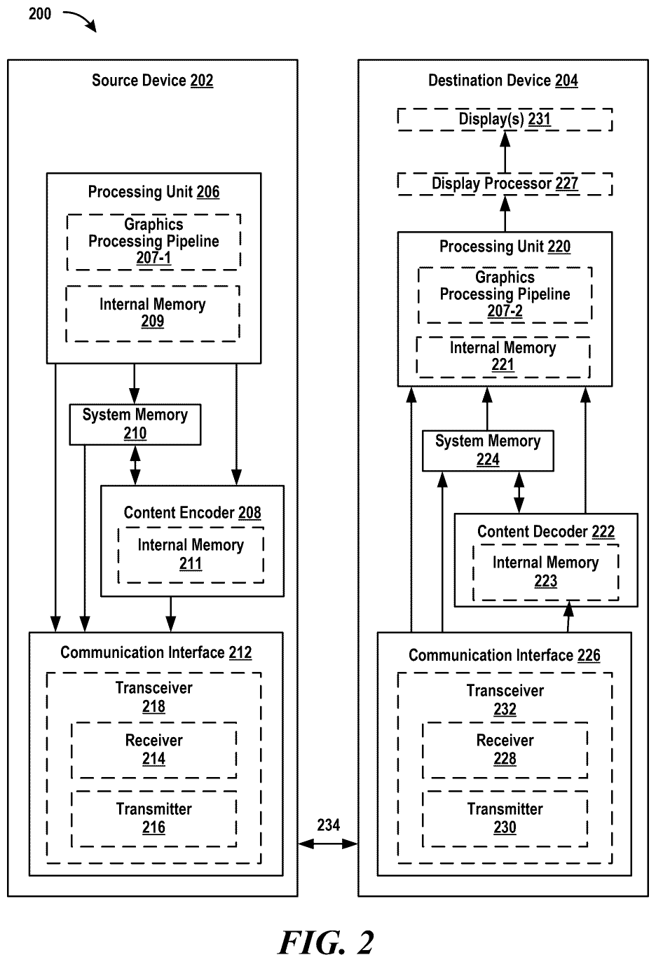

FIG. 2 is a block diagram that illustrates an example extended reality (XR) or virtual reality (VR) system 200 configured to implement extended reality (XR) or VR applications, according to aspects of the present disclosure. The system 200 includes a source device 202 and a destination device 204. In accordance with the techniques described, the source device 202 may be configured to encode, using the content encoder 208, graphical content generated by the processing unit 206 prior to transmission to the destination device 204. The content encoder 208 may be configured to output a bitstream having a bit rate. The processing unit 206 may be configured to control and/or influence the bit rate of the content encoder 208 based on how the processing unit 206 generates graphical content.

The source device 202 may include one or more components (or circuits) for performing various functions described. The destination device 204 may include one or more components (or circuits) for performing various functions described. In some examples, one or more components of the source device 202 may be components of a system-on-a-chip (SoC). Similarly, in some examples, one or more components of the destination device 204 may be components of an SoC.

The source device 202 may include one or more components configured to perform one or more techniques of this disclosure. In the example shown, the source device 202 may include a processing unit 206, a content encoder 208, a system memory 210, and a communication interface 212. The processing unit 206 may include an internal memory 209. The processing unit 206 may be configured to perform graphics processing, such as in a graphics processing pipeline 207-1. The content encoder 208 may include an internal memory 211.

Memory external to the processing unit 206 and the content encoder 208, such as system memory 210, may be accessible to the processing unit 206 and the content encoder 208. For example, the processing unit 206 and the content encoder 208 may be configured to read from and/or write to external memory, such as the system memory 210. The processing unit 206 and the content encoder 208 may be communicatively coupled to the system memory 210 over a bus. In some examples, the processing unit 206 and the content encoder 208 may be communicatively coupled to each other over the bus or a different connection.

The content encoder 208 may be configured to receive graphical content from any source, such as the system memory 210 and/or the processing unit 206. The system memory 210 may be configured to store graphical content generated by the processing unit 206. For example, the processing unit 206 may be configured to store graphical content in the system memory 210. The content encoder 208 may be configured to receive graphical content (e.g., from the system memory 210 and/or the processing unit 206) in the form of pixel data. Otherwise described, the content encoder 208 may be configured to receive pixel data of graphical content produced by the processing unit 206. For example, the content encoder 208 may be configured to receive a value for each component (e.g., each color component) of one or more pixels of graphical content. As an example, a pixel in the red, green, blue (RGB) color space may include a first value for the red component, a second value for the green component, and a third value for the blue component.

The internal memory 209, the system memory 210, and/or the internal memory 211 may include one or more volatile or non-volatile memories or storage devices. In some examples, internal memory 209, the system memory 210, and/or the internal memory 211 may include random access memory (RAM), static RAM (SRAM), dynamic RAM (DRAM), erasable programmable ROM (EPROM), electrically erasable programmable ROM (EEPROM), Flash memory, a magnetic data media or an optical storage media, or any other type of memory.

The internal memory 209, the system memory 210, and/or the internal memory 211 may be a non-transitory storage medium according to some examples. The term “non-transitory” may indicate that the storage medium is not embodied in a carrier wave or a propagated signal. However, the term “non-transitory” should not be interpreted to mean that internal memory 209, the system memory 210, and/or the internal memory 211 is non-movable or that its contents are static. As one example, the system memory 210 may be removed from the source device 202 and moved to another device. As another example, the system memory 210 may not be removable from the source device 202.

The processing unit 206 may be a central processing unit (CPU), a graphics processing unit (GPU), a general purpose GPU (GPGPU), or any other processing unit that may be configured to perform graphics processing. In some examples, the processing unit 206 may be integrated into a motherboard of the source device 202. In some examples, the processing unit 206 may be present on a graphics card that is installed in a port in a motherboard of the source device 202, or may be otherwise incorporated within a peripheral device configured to interoperate with the source device 202.

The processing unit 206 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 206 may store instructions for the software in a suitable, non-transitory computer-readable storage medium (e.g., internal memory 209), and may execute the instructions in hardware using one or more processors to perform the techniques of this disclosure. Any of the foregoing (including hardware, software, a combination of hardware and software, etc.) may be considered to be one or more processors.

The content encoder 208 may be any processing unit configured to perform content encoding. In some examples, the content encoder 208 may be integrated into a motherboard of the source device 202. The content encoder 208 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the content encoder 208 may store instructions for the software in a suitable, non-transitory computer-readable storage medium (e.g., internal memory 211), and may execute the instructions in hardware using one or more processors to perform the techniques of this disclosure. Any of the foregoing (including hardware, software, a combination of hardware and software, etc.) may be considered to be one or more processors.

The communication interface 212 may include a receiver 214 and a transmitter 216. The receiver 214 may be configured to perform any receiving function described with respect to the source device 202. For example, the receiver 214 may be configured to receive information from the destination device 204, which may include a request for content. In some examples, in response to receiving the request for content, the source device 202 may be configured to perform one or more techniques described, such as produce or otherwise generate graphical content for delivery to the destination device 204. The transmitter 216 may be configured to perform any transmitting function described with respect to the source device 202. For example, the transmitter 216 may be configured to transmit encoded content to the destination device 204, such as encoded graphical content produced by the processing unit 206 and the content encoder 208 (e.g., the graphical content is produced by the processing unit 206, which the content encoder 208 receives as input to produce or otherwise generate the encoded graphical content). The receiver 214 and the transmitter 216 may be combined into a transceiver 218. In such examples, the transceiver 218 may be configured to perform any receiving function and/or transmitting function described with respect to the source device 202.

The destination device 204 may include one or more components configured to perform one or more techniques of this disclosure. In the example shown, the destination device 204 may include a processing unit 220, a content decoder 222, a system memory 224, a communication interface 226, and one or more displays 231. Reference to the displays 231 may refer to the one or more displays 231. For example, the displays 231 may include a single display or multiple displays. The displays 231 may include a first display and a second display. The first display may be a left-eye display and the second display may be a right-eye display. In some examples, the first and second display may receive different frames for presentment thereon. In other examples, the first and second display may receive the same frames for presentment thereon.

The processing unit 220 may include an internal memory 221. The processing unit 220 may be configured to perform graphics processing, such as in a graphics processing pipeline 207-2. The content decoder 222 may include an internal memory 223. In some examples, the destination device 204 may include a display processor, such as the display processor 227, to perform one or more display processing techniques on one or more frames generated by the processing unit 220 before presentment by the one or more displays 231. The display processor 227 may be configured to perform display processing. For example, the display processor 227 may be configured to perform one or more display processing techniques on one or more frames generated by the processing unit 220. The one or more displays 231 may be configured to display content that was generated using decoded content. For example, the display processor 227 may be configured to process one or more frames generated by the processing unit 220, where the one or more frames are generated by the processing unit 220 by using decoded content that was derived from encoded content received from the source device 202. In turn the display processor 227 may be configured to perform display processing on the one or more frames generated by the processing unit 220. The one or more displays 231 may be configured to display or otherwise present frames processed by the display processor 227. In some examples, the one or more display devices may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 220 and the content decoder 222, such as system memory 224, may be accessible to the processing unit 220 and the content decoder 222. For example, the processing unit 220 and the content decoder 222 may be configured to read from and/or write to external memory, such as the system memory 224. The processing unit 220 and the content decoder 222 may be communicatively coupled to the system memory 224 over a bus. In some examples, the processing unit 220 and the content decoder 222 may be communicatively coupled to each other over the bus or a different connection.

The content decoder 222 may be configured to receive graphical content from any source, such as the system memory 224 and/or the communication interface 226. The system memory 224 may be configured to store received encoded graphical content, such as encoded graphical content received from the source device 202. The content decoder 222 may be configured to receive encoded graphical content (e.g., from the system memory 224 and/or the communication interface 226) in the form of encoded pixel data. The content decoder 222 may be configured to decode encoded graphical content.

The internal memory 221, the system memory 224, and/or the internal memory 223 may include one or more volatile or non-volatile memories or storage devices. In some examples, internal memory 221, the system memory 224, and/or the internal memory 223 may include random access memory (RAM), static RAM (SRAM), dynamic RAM (DRAM), erasable programmable ROM (EPROM), electrically erasable programmable ROM (EEPROM), Flash memory, a magnetic data media or an optical storage media, or any other type of memory.

The internal memory 221, the system memory 224, and/or the internal memory 223 may be a non-transitory storage medium according to some examples. The term “non-transitory” may indicate that the storage medium is not embodied in a carrier wave or a propagated signal. However, the term “non-transitory” should not be interpreted to mean that internal memory 221, the system memory 224, and/or the internal memory 223 is non-movable or that its contents are static. As one example, the system memory 224 may be removed from the destination device 204 and moved to another device. As another example, the system memory 224 may not be removable from the destination device 204.

The processing unit 220 may be a central processing unit (CPU), a graphics processing unit (GPU), a general purpose GPU (GPGPU), or any other processing unit that may be configured to perform graphics processing. In some examples, the processing unit 220 may be integrated into a motherboard of the destination device 204. In some examples, the processing unit 220 may be present on a graphics card that is installed in a port in a motherboard of the destination device 204, or may be otherwise incorporated within a peripheral device configured to interoperate with the destination device 204.

The processing unit 220 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 220 may store instructions for the software in a suitable, non-transitory computer-readable storage medium (e.g., internal memory 221), and may execute the instructions in hardware using one or more processors to perform the techniques of this disclosure. Any of the foregoing (including hardware, software, a combination of hardware and software, etc.) may be considered to be one or more processors.

The content decoder 222 may be any processing unit configured to perform content decoding. In some examples, the content decoder 222 may be integrated into a motherboard of the destination device 204. The content decoder 222 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the content decoder 222 may store instructions for the software in a suitable, non-transitory computer-readable storage medium (e.g., internal memory 223), and may execute the instructions in hardware using one or more processors to perform the techniques of this disclosure. Any of the foregoing (including hardware, software, a combination of hardware and software, etc.) may be considered to be one or more processors.

The communication interface 226 may include a receiver 228 and a transmitter 230. The receiver 228 may be configured to perform any receiving function described with respect to the destination device 204. For example, the receiver 228 may be configured to receive information from the source device 202, which may include encoded content, such as encoded graphical content produced or otherwise generated by the processing unit 206 and the content encoder 208 of the source device 202 (e.g., the graphical content is produced by the processing unit 206, which the content encoder 208 receives as input to produce or otherwise generate the encoded graphical content). As another example, the receiver 228 may be configured to receive position information from the source device 202, which may be encoded or unencoded (e.g., not encoded). In some examples, the destination device 204 may be configured to decode encoded graphical content received from the source device 202 in accordance with the techniques described. For example, the content decoder 222 may be configured to decode encoded graphical content to produce or otherwise generate decoded graphical content. The processing unit 220 may be configured to use the decoded graphical content to produce or otherwise generate one or more frames for presentment on the one or more displays 231. The transmitter 230 may be configured to perform any transmitting function described with respect to the destination device 204. For example, the transmitter 230 may be configured to transmit information to the source device 202, which may include a request for content. The receiver 228 and the transmitter 230 may be combined into a transceiver 232. In such examples, the transceiver 232 may be configured to perform any receiving function and/or transmitting function described with respect to the destination device 204.

The content encoder 208 and the content decoder 222 of XR gaming system 200 represent examples of computing components (e.g., processing units) that may be configured to perform one or more techniques for encoding content and decoding content in accordance with various examples described in this disclosure, respectively. In some examples, the content encoder 208 and the content decoder 222 may be configured to operate in accordance with a content coding standard, such as a video coding standard, a display stream compression standard, or an image compression standard.

As shown in FIG. 2, the source device 202 may be configured to generate encoded content. Accordingly, the source device 202 may be referred to as a content encoding device or a content encoding apparatus. The destination device 204 may be configured to decode the encoded content generated by source device 202. Accordingly, the destination device 204 may be referred to as a content decoding device or a content decoding apparatus. In some examples, the source device 202 and the destination device 204 may be separate devices, as shown. In other examples, source device 202 and destination device 204 may be on or part of the same computing device. In either example, a graphics processing pipeline may be distributed between the two devices. For example, a single graphics processing pipeline may include a plurality of graphics processes. The graphics processing pipeline 207-1 may include one or more graphics processes of the plurality of graphics processes. Similarly, graphics processing pipeline 207-2 may include one or more processes graphics processes of the plurality of graphics processes. In this regard, the graphics processing pipeline 207-1 concatenated or otherwise followed by the graphics processing pipeline 207-2 may result in a full graphics processing pipeline. Otherwise described, the graphics processing pipeline 207-1 may be a partial graphics processing pipeline and the graphics processing pipeline 207-2 may be a partial graphics processing pipeline that, when combined, result in a distributed graphics processing pipeline.

In some examples, a graphics process performed in the graphics processing pipeline 207-1 may not be performed or otherwise repeated in the graphics processing pipeline 207-2. For example, the graphics processing pipeline 207-1 may include receiving first position information corresponding to a first orientation of a device. The graphics processing pipeline 207-1 may also include generating first graphical content based on the first position information. Additionally, the graphics processing pipeline 207-1 may include generating motion information for warping the first graphical content. The graphics processing pipeline 207-1 may further include encoding the first graphical content. Also, the graphics processing pipeline 207-1 may include providing the motion information and the encoded first graphical content. The graphics processing pipeline 207-2 may include providing first position information corresponding to a first orientation of a device. The graphics processing pipeline 207-2 may also include receiving encoded first graphical content generated based on the first position information. Further, the graphics processing pipeline 207-2 may include receiving motion information. The graphics processing pipeline 207-2 may also include decoding the encoded first graphical content to generate decoded first graphical content. Also, the graphics processing pipeline 207-2 may include warping the decoded first graphical content based on the motion information. By distributing the graphics processing pipeline between the source device 202 and the destination device 204, the destination device may be able to, in some examples, present graphical content that it otherwise would not be able to render; and, therefore, could not present. Other example benefits are described throughout this disclosure.

As described, a device, such as the source device 202 and/or the destination device 204, may refer to any device, apparatus, or system configured to perform one or more techniques described. For example, a device may be a server, a base station, user equipment, a client device, a station, an access point, a computer (e.g., a personal computer, a desktop computer, a laptop computer, a tablet computer, a computer workstation, or a mainframe computer), an end product, an apparatus, a phone, a smart phone, a server, a video game platform or console, a handheld device (e.g., a portable video game device or a personal digital assistant (PDA)), a wearable computing device (e.g., a smart watch, an augmented reality device, or a virtual reality device), a non-wearable device, an augmented reality device, a virtual reality device, a display (e.g., display device), a television, a television set-top box, an intermediate network device, a digital media player, a video streaming device, a content streaming device, an in-car computer, any mobile device, any device configured to generate graphical content, or any device configured to perform one or more techniques described.

Source device 202 may be configured to communicate with the destination device 204. For example, destination device 204 may be configured to receive encoded content from the source device 202. In some example, the communication coupling between the source device 202 and the destination device 204 is shown as link 234. Link 234 may comprise any type of medium or device capable of moving the encoded content from source device 202 to the destination device 204.

In the example of FIG. 2, link 234 may comprise a communication medium to enable the source device 202 to transmit encoded content to destination device 204 in real-time. The encoded content may be modulated according to a communication standard, such as a wireless communication protocol, and transmitted to destination device 204. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 202 to the destination device 204. In other examples, link 234 may be a point-to-point connection between source device 202 and destination device 204, such as a wired or wireless display link connection (e.g., a high-definition multimedia interface (HDMI) link, a DisplayPort link, mobile industry processor interface (MIPI) display serial interface (DSI) link, or another link over which encoded content may traverse from the source device 202 to the destination device 204.

In another example, the link 234 may include a storage medium configured to store encoded content generated by the source device 202. In this example, the destination device 204 may be configured to access the storage medium. The storage medium may include a variety of locally-accessed data storage media such as Blu-ray discs, DVDs, CD-ROMs, flash memory, or other suitable digital storage media for storing encoded content.

In another example, the link 234 may include a server or another intermediate storage device configured to store encoded content generated by the source device 202. In this example, the destination device 204 may be configured to access encoded content stored at the server or other intermediate storage device. The server may be a type of server capable of storing encoded content and transmitting the encoded content to the destination device 204.

Devices described may be configured to communicate with each other, such as the source device 202 and the destination device 204. Communication may include the transmission and/or reception of information. The information may be carried in one or more messages. As an example, a first device in communication with a second device may be described as being communicatively coupled to or otherwise with the second device. For example, a client device and a server may be communicatively coupled. As another example, a server may be communicatively coupled to multiple client devices. As another example, any device described configured to perform one or more techniques of this disclosure may be communicatively coupled to one or more other devices configured to perform one or more techniques of this disclosure. In some examples, when communicatively coupled, two devices may be actively transmitting or receiving information, or may be configured to transmit or receive information. If not communicatively coupled, any two devices may be configured to communicatively couple with each other, such as in accordance with one or more communication protocols compliant with one or more communication standards. Reference to “any two devices” does not mean that only two devices may be configured to communicatively couple with each other; rather, any two devices are inclusive of more than two devices. For example, a first device may communicatively couple with a second device and the first device may communicatively couple with a third device. In such an example, the first device may be a server.

With reference to FIG. 2, the source device 202 may be described as being communicatively coupled to the destination device 204. In some examples, the term “communicatively coupled” may refer to a communication connection, which may be direct or indirect. The link 234 may, in some examples, represent a communication coupling between the source device 202 and the destination device 204. A communication connection may be wired and/or wireless. A wired connection may refer to a conductive path, a trace, or a physical medium (excluding wireless physical mediums) over which information may travel. A conductive path may refer to any conductor of any length, such as a conductive pad, a conductive via, a conductive plane, a conductive trace, or any conductive medium. A direct communication connection may refer to a connection in which no intermediary component resides between the two communicatively coupled components. An indirect communication connection may refer to a connection in which at least one intermediary component resides between the two communicatively coupled components. Two devices that are communicatively coupled may communicate with each other over one or more different types of networks (e.g., a wireless network and/or a wired network) in accordance with one or more communication protocols. In some examples, two devices that are communicatively coupled may associate with one another through an association process. In other examples, two devices that are communicatively coupled may communicate with each other without engaging in an association process. For example, a device, such as the source device 202, may be configured to unicast, broadcast, multicast, or otherwise transmit information (e.g., encoded content) to one or more other devices (e.g., one or more destination devices, which includes the destination device 204). The destination device 204 in this example may be described as being communicatively coupled with each of the one or more other devices. In some examples, a communication connection may enable the transmission and/or receipt of information. For example, a first device communicatively coupled to a second device may be configured to transmit information to the second device and/or receive information from the second device in accordance with the techniques of this disclosure. Similarly, the second device in this example may be configured to transmit information to the first device and/or receive information from the first device in accordance with the techniques of this disclosure. In some examples, the term “communicatively coupled” may refer to a temporary, intermittent, or permanent communication connection.

Any device described, such as the source device 202 and the destination device 204, may be configured to operate in accordance with one or more communication protocols. For example, the source device 202 may be configured to communicate with (e.g., receive information from and/or transmit information to) the destination device 204 using one or more communication protocols. In such an example, the source device 202 may be described as communicating with the destination device 204 over a connection. The connection may be compliant or otherwise be in accordance with a communication protocol. Similarly, the destination device 204 may be configured to communicate with (e.g., receive information from and/or transmit information to) the source device 202 using one or more communication protocols. In such an example, the destination device 204 may be described as communicating with the source device 202 over a connection. The connection may be compliant or otherwise be in accordance with a communication protocol.

The term “communication protocol” may refer to any communication protocol, such as a communication protocol compliant with a communication standard or the like. As used, the term “communication standard” may include any communication standard, such as a wireless communication standard and/or a wired communication standard. A wireless communication standard may correspond to a wireless network. As an example, a communication standard may include any wireless communication standard corresponding to a wireless personal area network (WPAN) standard, such as BLUETOOTH (e.g., IEEE 802.15), BLUETOOTH low energy (BLE) (e.g., IEEE 802.15.4). As another example, a communication standard may include any wireless communication standard corresponding to a wireless local area network (WLAN) standard, such as WI-FI (e.g., any 802.11 standard, such as 802.11a, 802.11b, 802.11c, 802.11n, or 802.11ax). As another example, a communication standard may include any wireless communication standard corresponding to a wireless wide area network (WWAN) standard, such as 3G, 4G, 4G LTE, 5G, or 6G.

With reference to FIG. 2, the content encoder 208 may be configured to encode graphical content. In some examples, the content encoder 208 may be configured to encode graphical content as one or more video frames of extended reality (XR) or virtual reality (VR) content. When the content encoder 208 encodes content, the content encoder 208 may generate a bitstream. The bitstream may have a bit rate, such as bits/time unit, where time unit is any time unit, such as second or minute. The bitstream may include a sequence of bits that form a coded representation of the graphical content and associated data. To generate the bitstream, the content encoder 208 may be configured to perform encoding operations on pixel data, such as pixel data corresponding to a shaded texture atlas. For example, when the content encoder 208 performs encoding operations on image data (e.g., one or more blocks of a shaded texture atlas) provided as input to the content encoder 208, the content encoder 208 may generate a series of coded images and associated data. The associated data may include a set of coding parameters such as a quantization parameter (QP).

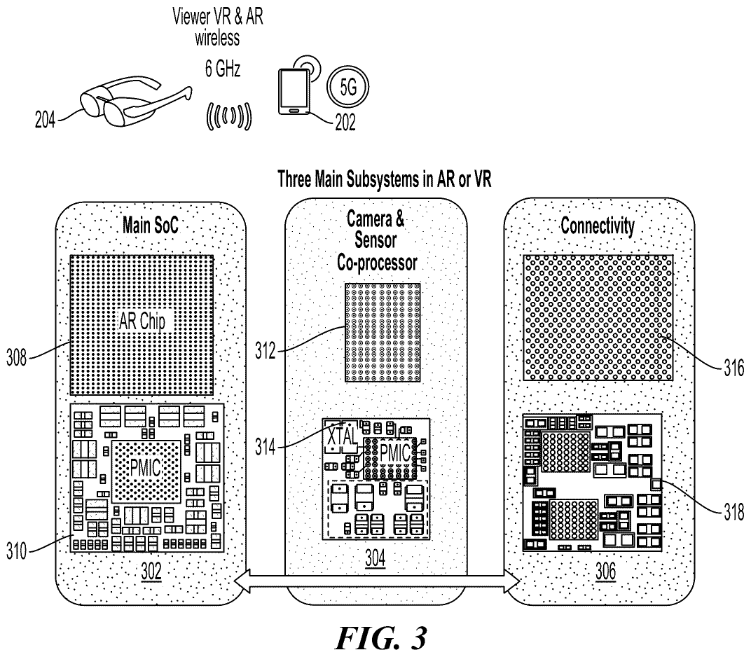

As shown in FIG. 1, a single printed circuit board (PCB) may support multiple components of the SoC 100, including the CPU 102, GPU 104, DSP 106, etc. For an AR or VR device, the components may be located on different PCBs. FIG. 3 is a block diagram illustrating augmented reality or virtual reality subsystems, according to aspects of the present disclosure. As seen in the example of FIG. 3, the destination device 204 may be in the form of eyeglasses and the source device 202 may be in the form of a mobile device. If the destination device 204 has an eyeglasses form factor, the various components may be distributed across multiple PCBs 302, 304, 306 in a multi-PCB architecture. For example, a master or main SoC 308 and a master power management integrated circuit (PMIC) 310 may reside on a first PCB 302, a camera and sensor co-processor 312 and associated PMIC 314 may reside on a second PCB 304, and a connectivity processor 316 and associated PMIC 318 may reside on a third PCB 306. Due to the separate locations of the PCBs 302, 304, 306, the length of connectors between the PCBs 302, 304, 306 may exceed design specifications. Moreover, the connectors may be arranged in a multi-drop configuration, which also impedes performance due to stubs and reflections. Flexible PCBs may also be used between PCBs 302, 304, 306, which may further impact signal integrity.

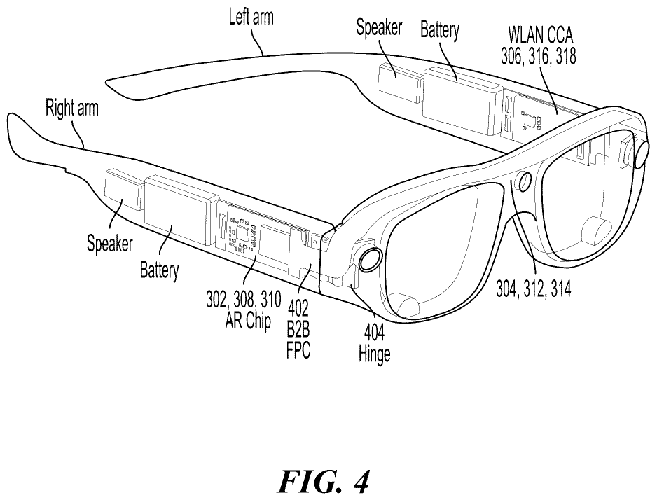

FIG. 4 is a diagram illustrating placement of components in a device with an eyeglasses form factor, in accordance with aspects of the present disclosure. As seen in the example of FIG. 4, the master SoC 308 and master power management IC (PMIC) 310 may reside on the first PCB 302 (also referred to as CCA-circuit card assembly) in one arm of the glasses, the camera and sensor co-processor 312 and associated PMIC 314 may reside on the second PCB 304 on the bridge of the eyeglasses, and the connectivity processor 316 and associated PMIC 318 may reside on the third PCB 306 on another arm of the glasses. Location of batteries and speakers are also shown in FIG. 4. A board-to-board (B2B) flexible printed circuit (FPC) connector 402 couples the first PCB 302, the second PCB 304, and the third PCB 306 across hinges 404 (only one labelled) of the eyeglasses.

For wider market adoption, augmented reality (AR) glasses should be lightweight with a small form factor (e.g., sleek form factor). In fact, original equipment manufacturers (OEMs) may specify maximum dimension limits to achieve the sleek form factor. The sleek form factor, however, restricts chip count, chip package size, battery size, and battery capacity. Lower power consumption may improve the user experience by allowing a lower battery capacity and thus a smaller battery.

Extended reality (XR) chipsets support a find my device (FMD) feature (also referred to as a device search mode) to assist the user in case of misplacing the device. Traditionally, find my device is a chipset state where the main system-on-a-chip (SoC) is OFF, and a connectivity SoC is operational with BLUETOOTH low energy (BLE) technology enabled.

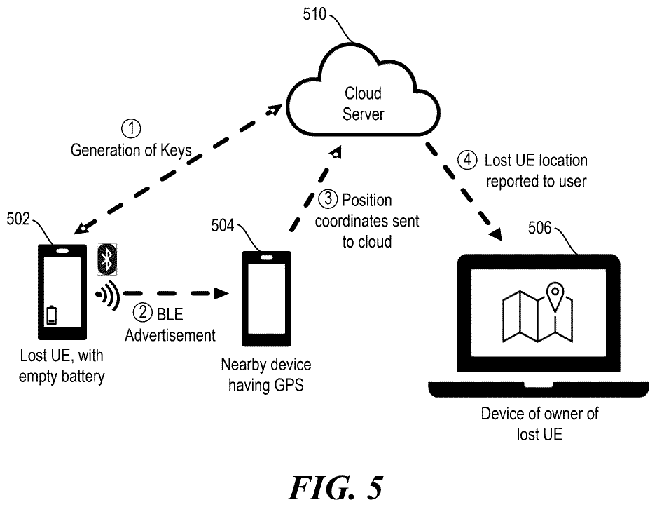

FIG. 5 is a diagram illustrating an example of a find my device operation, in accordance with various aspects of the present disclosure. In the example of FIG. 5, a lost UE 502 has a low battery status. The lost UE 502 communicates with a cloud server 510 to generate a key for identifying and distinguishing a lost device. In find my device mode, the lost UE 502 transmits a periodic BLE advertisement that is scanned by a neighbor device 504. The BLE advertisement is encrypted and thus the neighbor device 504 is unaware of the content of the advertisement, only knowing that the neighbor device 504 should communicate to the cloud server 510. Accordingly, the neighbor device 504 communicates with the cloud server 510 to forward global positioning system (GPS) position coordinates of the lost UE 502 by forwarding the location of the neighbor device 504. As a result, at an owner device 506, an owner of the lost UE 502 receives a report of the location of the lost UE 502.

In the current chipset architecture, the find my device feature (e.g., search mode) is activated during a low battery event when the SoC is fully power collapsed. Specifically, a user enables the search mode while operating the device. For example, the search mode may be enabled in a control panel. Based on the user enabling the search mode, when the device enters the low power mode, the device initiates the search mode. If the user does not configure the search mode, the device does not enter the search mode when entering the low power mode. Accordingly, user input (e.g., an action by the user) is required to enter the search mode.

In the case of extended reality (XR) devices, the SoC enters an SoC sleep state based on how long the XR device is in an idle state. Entry into deeper low power modes, such as deep sleep, is user command driven and not based on the SoC workload or how long the device is in an idle state. Deep sleep may be a state where a memory power rail is collapsed, whereas a rock bottom state is a state where the memory rail remains powered on so that device state can be more quickly recovered when exiting the rock bottom state. That is, states of some subsystems may be retained, for example, saved in a dynamic random access memory (DRAM) that remains powered up.

For XR devices that are not in a low battery state, the search feature is not initiated (e.g., activated) without prior user action when the SoC eventually enters an SoC sleep state, or rock bottom state (RBS). That is, the search mode is initiated only when the device is in a low battery state and the user previously enabled the search mode. Thus, in a scenario where the user misplaced the XR device with a sufficient charge level and without having enabled the search mode, with the current architecture, the search mode cannot be utilized by the user to locate the device. Power drain continues for the SoC and device during a deep sleep or lower low power mode (LPM) state. Hence, the SoC and the XR device would shut down after a relatively short duration with no way for the user to find the device, if left unattended for a long duration. If the device has sufficient battery, the search mode is not initiated unless the user enables the search mode in settings, beforehand.

Aspects of the present disclosure introduce a solution for initiated a search mode in an enhanced quiescent (SEEQ) state for XR devices. The solution leverages the power benefit and quick exit time of deep sleep and quick boot combined with the find my device feature (e.g., search mode). The proposed solution may be implemented in augmented reality (AR)/XR chipsets.

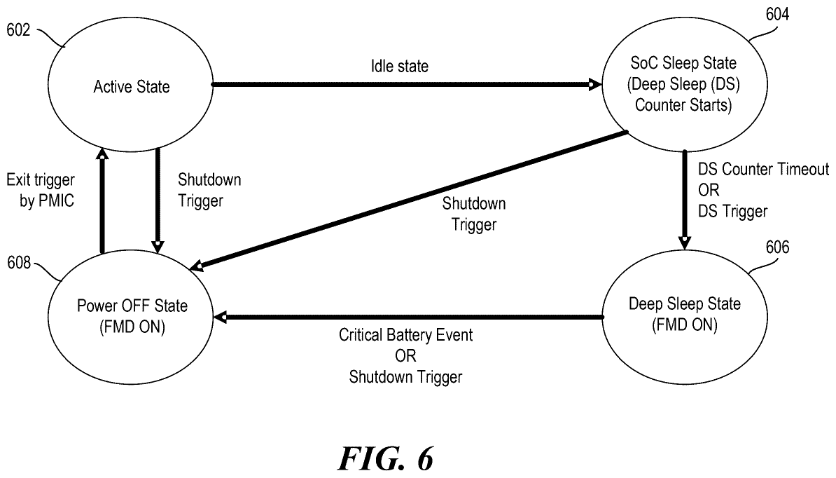

FIG. 6 is a state transition diagram for activating device search mode while in a device idle state, in accordance with various aspects of the present disclosure. The state transition diagram illustrates the control flow during the device idle state. From an active state 602, the device enters an idle state (e.g., the RBS) or an SoC sleep state 604, and a deep sleep (DS) counter begins. In this example, the user has not enabled the search mode beforehand while in active mode. When the deep sleep counter times out or a deep sleep is triggered, the device enters a deep sleep state 606. While in the deep sleep state 606, the device enters a search (e.g., find my device (FMD)) mode.

In response to a shutdown trigger at the SoC sleep state 604, the active state 602, or the deep sleep state 606, or in response to a critical battery event at the deep sleep state 606, the device enters a power OFF (P_OFF) state 608. The search (e.g., find my device (FMD)) mode is still initiated while in the power OFF state 608. Thus, if the device becomes lost, the user may be able to locate the device. In these aspects the search mode is initiated without the user enabling the search mode beforehand. In response to an exit trigger by a power management integrated circuit (PMIC), the device leaves the power OFF state 608 and returns to the active state 602. Examples of an exit trigger at the device are plugging in a power charger or a long press of a power button.

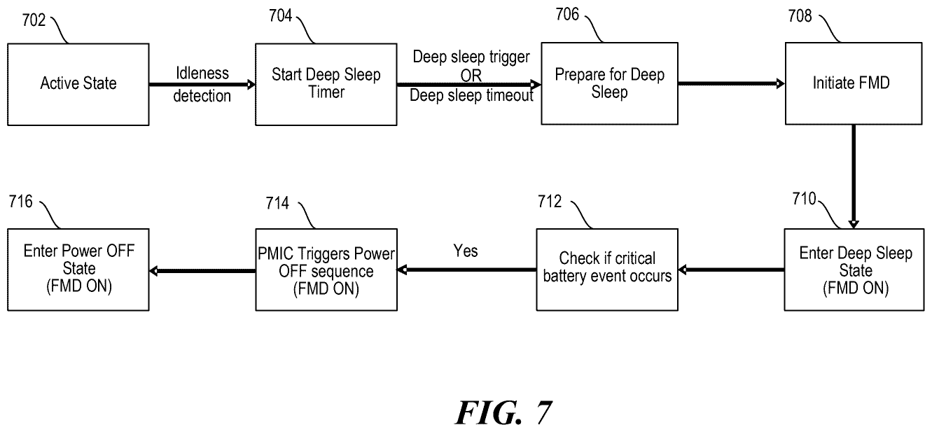

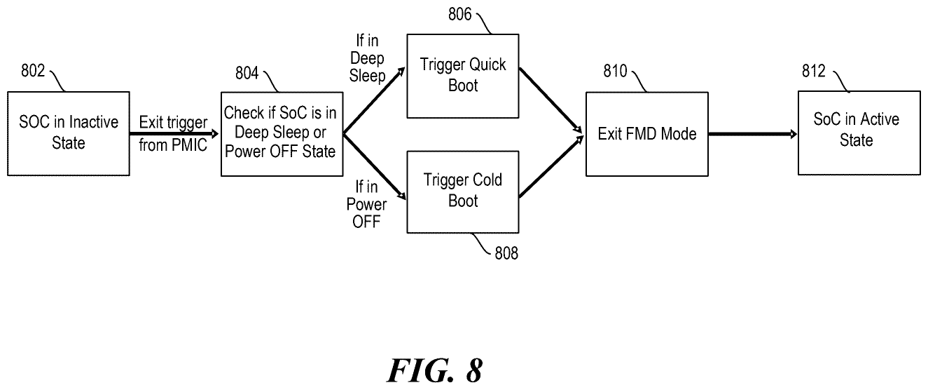

FIG. 7 is a flow diagram illustrating entry into a device search mode while in a device idle state, in accordance with various aspects of the present disclosure. FIG. 8 is a flow diagram illustrating exit of a device search mode when leaving a device idle state, in accordance with various aspects of the present disclosure. The entry flow of FIG. 7 utilizes a deep sleep framework to save chipset power while the find my device mode is switched on. On the exit path, either a quick boot or a cold boot is triggered and the find my device mode is exited.

Referring now to FIG. 7, at block 702, the device is in an active state. In response to detecting idleness, at block 704, the device starts a deep sleep timer. If a deep sleep trigger or a deep sleep timeout occurs, at block 706, the device prepares for deep sleep. At block 708, the device initiates the device search (e.g., find my device (FMD)) mode. At block 710, the device enters the deep sleep state with the device search (e.g., find my device (FMD)) mode being ON. At block 712, the device checks whether a low battery status is present (e.g., whether a critical battery event has occurred). Examples of a low battery status may be 3% or 5% of full battery power. If a low battery status is detected, at block 714, the PMIC triggers a power OFF sequence, while the device search (e.g., find my device (FMD)) mode remains ON. At block 716, the device enters a power OFF state with the device search (e.g., find my device (FMD)) mode being ON.

The exit path of FIG. 8 will now be described. At block 802, the SoC is in an inactive state. Upon receiving an exit trigger from a PMIC, at block 804, the device checks whether the SoC is in a deep sleep or power OFF state. If the device is in the deep sleep state, at block 806, a quick boot process is triggered. If the SoC is in the power OFF state, at block 808, a cold boot process is triggered. After triggering the quick boot or cold boot process, at block 810, device search (e.g., find my device (FMD)) mode is exited. At block 812, the SoC returns to the active state.

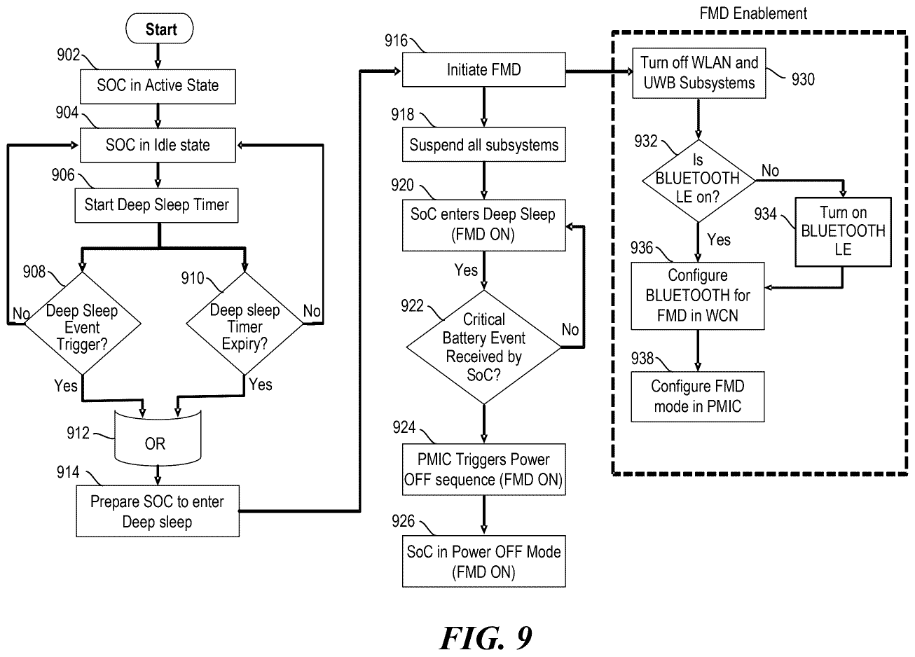

FIG. 9 is a flow diagram illustrating further details for enabling a device search mode while in a device idle state, in accordance with various aspects of the present disclosure. In the example of FIG. 9, at block 902, the SoC is in an active state. At block 904, the SoC enters an idle state. At block 906, a deep sleep timer starts. At block 908, it is determined whether a deep sleep event trigger has occurred. If not, the process returns to block 904. If so, the process continues to block 912. At block 910, it is determined whether a deep sleep timer has expired. If not, the process returns to block 904. Otherwise, the process continues to block 912.

At block 912, it is determined whether the deep sleep event was triggered or if the deep sleep timer expired. If either occurred, at block 914, the SoC prepares to enter deep sleep. At block 916, the device initiates device search (e.g., find my device (FMD)) mode. Details of initiating (e.g., activating) the device search (e.g., find my device (FMD)) mode will be described below.

At block 918, all subsystems are suspended. At block 920, the SoC enters deep sleep with the device search (e.g., find my device (FMD)) mode ON. At block 922, it is determined whether the SoC receives a critical battery event. If not, the process returns to block 920. If so, at block 922, the PMIC triggers a power OFF sequence, while the device search (e.g., find my device (FMD)) mode remains ON. At block 926, the SoC enters the power OFF mode with the search (e.g., find my device (FMD)) mode remaining ON.

Initiating the device search (e.g., find my device (FMD)) mode is now described in more detail. After initiating the device search (e.g., find my device (FMD)) mode at block 916, the device turns off wireless local area network (WLAN) and ultra-wide band (UWB) subsystems. At block 932, it is determined whether BLUETOOTH low energy (LE) is ON. If not, BLUETOOTH LE is turned ON at block 934. Next, and also if BLUETOOTH LE is already ON, at block 936, BLUETOOTH is configured for the device search (e.g., find my device (FMD)) mode in a wireless connectivity network (WCN), for example, a connectivity SoC. Finally, at block 938, the device search (e.g., find my device (FMD)) mode is configured in the PMIC. For example, a bit may be set in a shared direct access memory (SDAM), a memory register, or any other type of small memory.

During deep sleep mode with the device search (e.g., find my device (FMD)) mode initiated, lower power consumption occurs, compared to the RBS. Thus, longer battery life is available. Moreover, the quick boot process reduces the exit time. When powered OFF while in the device search (e.g., find my device (FMD)) mode, exit time latency increases. However, additional power savings are achieved. Aspects of the present disclosure provide a power efficient solution for XR devices in idle, unattended mode. The solution assists a user in locating the XR device in case of misplacement, even if the device is not in a low battery scenario. The entry path leverages deep sleep and quick boot features to further enhance the battery life of the device. On the exit path, because the quick boot process is utilized, the exit latency is significantly reduced compared to returning from a power OFF state.

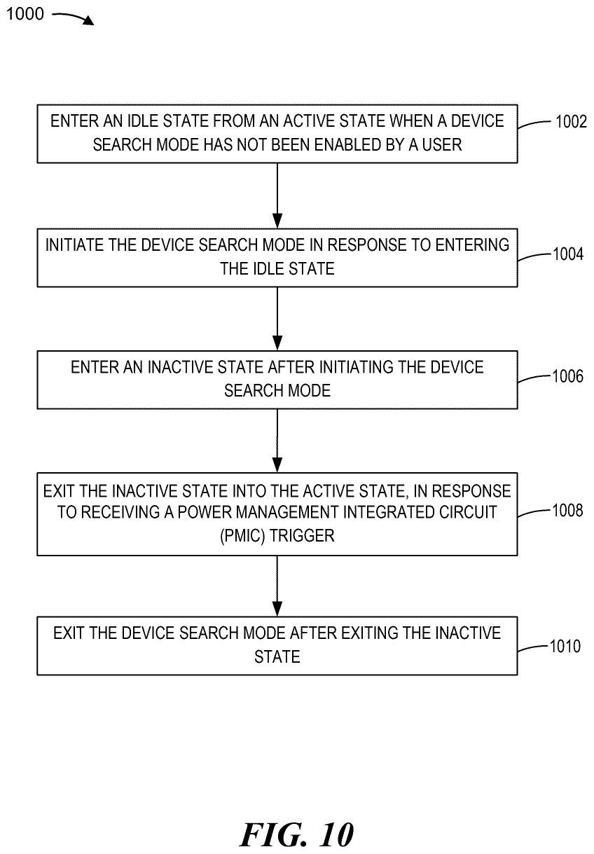

FIG. 10 is a flow diagram illustrating entry and exit of a device search mode, in accordance with various aspects of the present disclosure. As shown in FIG. 10, in some aspects, the process 1000 may include entering an idle state from an active state when a device search mode has not been enabled by a user (block 1002).

In some aspects, the process 1000 may include initiating the device search mode in response to entering the idle state (block 1004). Initiating the device search mode may include turning off wireless local area network (WLAN) and ultra-wideband (UWB) subsystems; configuring a connectivity SoC with BLUETOOTH low energy (LE) for the device search mode; and configuring the device search mode in a power management integrated circuit (PMIC).

In some aspects, the process 1000 may include entering an inactive state after initiating the device search mode (block 1006). In some aspects, the process 1000 may include exiting the inactive state into the active state, in response to receiving a power management integrated circuit (PMIC) trigger (block 1008). If the inactive state comprises a deep sleep state, then exiting the deep sleep state may comprise triggering a quick boot process. If the inactive state comprises a power OFF state, exiting the power OFF state may comprise triggering a cold boot process.

In some aspects, the process 1000 may include exiting the device search mode after exiting the inactive state (block 1010).

### Example Aspects

Aspect 1: A system-on-a-chip (SoC) low power mode method, comprising: entering an idle state from an active state, in which a device search mode has not been enabled by a user; initiating the device search mode in response to entering the idle state; entering an inactive state after initiating the device search mode; exiting the inactive state into the active state, in response to receiving a power management integrated circuit (PMIC) trigger; and exiting the device search mode after exiting the inactive state.

Aspect 2: The method of Aspect 1, in which the inactive state comprises a deep sleep state and exiting the deep sleep state comprises triggering a quick boot process.

Aspect 3: The method of Aspect 1 or 2, in which entering the deep sleep state occurs in response to either a deep sleep event trigger or expiration of a deep sleep timer.

Aspect 4: The method of Aspect 1, in which the inactive state comprises a power OFF state and exiting the power OFF state comprises triggering a cold boot process.

Aspect 5: The method of Aspect 1 or 4, in which entering the power OFF state occurs in response to detecting a low battery status.

Aspect 6: The method of any of the preceding Aspects, in which initiating the device search mode comprises: turning off wireless local area network (WLAN) and ultra-wideband (UWB) subsystems; and configuring a connectivity SoC with BLUETOOTH low energy (LE) for the device search mode; and configuring the device search mode in a power management integrated circuit (PMIC).

Aspect 7: An apparatus, comprising: at least one memory; and at least one processor coupled to the at least one memory, the at least one processor configured: to enter an idle state from an active state, in which a device search mode has not been enabled by a user; to initiate the device search mode in response to entering the idle state; to enter an inactive state after initiating the device search mode; to exit the inactive state into the active state, in response to receiving a power management integrated circuit (PMIC) trigger; and to exit the device search mode after exiting the inactive state.

Aspect 8: The apparatus of Aspect 7, in which the inactive state comprises a deep sleep state and exiting the deep sleep state comprises triggering a quick boot process.

Aspect 9: The apparatus of Aspect 7 or 8, in which the at least one processor is further configured to enter the deep sleep state in response to either a deep sleep event trigger or expiration of a deep sleep timer.

Aspect 10: The apparatus of Aspect 7, in which the inactive state comprises a power OFF state and exiting the power OFF state comprises triggering a cold boot process.

Aspect 11: The apparatus of any of the Aspects 7 or 10, in which the at least one processor is further configured to enter the power OFF state in response to detecting a low battery status.

Aspect 12: The apparatus of any of the Aspects 7-11, in which the at least one processor is further configured: to turn off wireless local area network (WLAN) and ultra-wideband (UWB) subsystems; and to configure a connectivity SoC with BLUETOOTH low energy (LE) for the device search mode; and to configure the device search mode in a power management integrated circuit (PMIC).

Aspect 13: A non-transitory computer-readable medium having program code recorded thereon, the program code executed by a processor and comprising: program code to enter an idle state from an active state, in which a device search mode has not been enabled by a user; program code to initiate the device search mode in response to entering the idle state; program code to enter an inactive state after initiating the device search mode; program code to exit the inactive state into the active state, in response to receiving a power management integrated circuit (PMIC) trigger; and program code to exit the device search mode after exiting the inactive state.

Aspect 14: The non-transitory computer-readable medium of Aspect 13, in which the inactive state comprises a deep sleep state and exiting the deep sleep state comprises triggering a quick boot process.

Aspect 15: The non-transitory computer-readable medium of Aspect 13 or 14, in which the program code comprises program code to enter the deep sleep state occurs in response to either a deep sleep event trigger or expiration of a deep sleep timer.

Aspect 16: The non-transitory computer-readable medium of Aspect 13, in which the inactive state comprises a power OFF state and exiting the power OFF state comprises triggering a cold boot process.

Aspect 17: The non-transitory computer-readable medium of any of the Aspects 13 or 16, in which the program code comprises program code to enter the power OFF state occurs in response to detecting a low battery status.

Aspect 18: The non-transitory computer-readable medium of any of the Aspects 13-18, in which the program code comprises: program code to turn off wireless local area network (WLAN) and ultra-wideband (UWB) subsystems; and program code to configure a connectivity SoC with BLUETOOTH low energy (LE) for the device search mode; and program code to configure the device search mode in a power management integrated circuit (PMIC).

In accordance with this disclosure, the term “or” may be interrupted as “and/or” where context does not dictate otherwise. Additionally, while phrases such as “one or more” or “at least one” or the like may have been used for some features disclosed but not others; the features for which such language was not used may be interpreted to have such a meaning implied where context does not dictate otherwise.

In one or more examples, the functions described may be implemented in hardware, software, firmware, or any combination thereof. For example, although the term “processing unit” has been used throughout this disclosure, such processing units may be implemented in hardware, software, firmware, or any combination thereof. If any function, processing unit, technique described, or other module is implemented in software, the function, processing unit, technique described, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices, Disk and disc, as used, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used may refer to any of the foregoing structure or any other structure suitable for implementation of the techniques described. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily require realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A system-on-a-chip (SoC) low power mode method, comprising:
entering an idle state from an active state, in which a device search mode has not been enabled by a user;
initiating the device search mode in response to entering the idle state;
entering an inactive state after initiating the device search mode;
exiting the inactive state into the active state, in response to receiving a power management integrated circuit (PMIC) trigger; and
exiting the device search mode after exiting the inactive state.

2. The method of claim 1, in which the inactive state comprises a deep sleep state and exiting the deep sleep state comprises triggering a quick boot process.

3. The method of claim 2, in which entering the deep sleep state occurs in response to either a deep sleep event trigger or expiration of a deep sleep timer.

4. The method of claim 1, in which the inactive state comprises a power OFF state and exiting the power OFF state comprises triggering a cold boot process.

5. The method of claim 4, in which entering the power OFF state occurs in response to detecting a low battery status.

6. The method of claim 1, in which initiating the device search mode comprises:
turning off wireless local area network (WLAN) and ultra-wideband (UWB) subsystems;
configuring a connectivity SoC with BLUETOOTH low energy (LE) for the device search mode; and
configuring the device search mode in a power management integrated circuit (PMIC).

7. An apparatus, comprising:
at least one memory; and
at least one processor coupled to the at least one memory, the at least one processor configured:
to enter an idle state from an active state, in which a device search mode has not been enabled by a user;
to initiate the device search mode in response to entering the idle state;
to enter an inactive state after initiating the device search mode;
to exit the inactive state into the active state, in response to receiving a power management integrated circuit (PMIC) trigger; and
to exit the device search mode after exiting the inactive state.

8. The apparatus of claim 7, in which the inactive state comprises a deep sleep state and exiting the deep sleep state comprises triggering a quick boot process.

9. The apparatus of claim 8, in which the at least one processor is further configured to enter the deep sleep state in response to either a deep sleep event trigger or expiration of a deep sleep timer.

10. The apparatus of claim 7, in which the inactive state comprises a power OFF state and exiting the power OFF state comprises triggering a cold boot process.

11. The apparatus of claim 10, in which the at least one processor is further configured to enter the power OFF state in response to detecting a low battery status.

12. The apparatus of claim 7, in which the at least one processor is further configured:
to turn off wireless local area network (WLAN) and ultra-wideband (UWB) subsystems;
to configure a connectivity SoC with BLUETOOTH low energy (LE) for the device search mode; and
to configure the device search mode in a power management integrated circuit (PMIC).

13. A non-transitory computer-readable medium having program code recorded thereon, the program code executed by a processor and comprising:
program code to enter an idle state from an active state, in which a device search mode has not been enabled by a user;
program code to initiate the device search mode in response to entering the idle state;
program code to enter an inactive state after initiating the device search mode;
program code to exit the inactive state into the active state, in response to receiving a power management integrated circuit (PMIC) trigger; and
program code to exit the device search mode after exiting the inactive state.

14. The non-transitory computer-readable medium of claim 13, in which the inactive state comprises a deep sleep state and exiting the deep sleep state comprises triggering a quick boot process.

15. The non-transitory computer-readable medium of claim 14, in which the program code comprises program code to enter the deep sleep state occurs in response to either a deep sleep event trigger or expiration of a deep sleep timer.

16. The non-transitory computer-readable medium of claim 13, in which the inactive state comprises a power OFF state and exiting the power OFF state comprises triggering a cold boot process.

17. The non-transitory computer-readable medium of claim 16, in which the program code comprises program code to enter the power OFF state occurs in response to detecting a low battery status.

18. The non-transitory computer-readable medium of claim 13, in which the program code comprises:
program code to turn off wireless local area network (WLAN) and ultra-wideband (UWB) subsystems;
program code to configure a connectivity SoC with BLUETOOTH low energy (LE) for the device search mode; and
program code to configure the device search mode in a power management integrated circuit (PMIC).
